(19) United States
(12) Patent Application Publication
(10) Pub. No.: US 2004/0021545 A1
(43) Pub. Date: Feb. 5, 2004

(54) Thermally tripped circuit breaker

(76) Inventor: Jurgen Liebe, Neumarkt/Oberpfalz (DE)

Correspondence Address: LERNER AND GREENBERG, P.A., POST OFFICE BOX 2480, HOLLYWOOD, FL, 33022-2480, US

(21) Appl. No.: 10/607,473

(22) Filed: Jun. 26, 2003

Related U.S. Application Data
(63) Continuation of application No. PCT/EP02/00701, filed on Jan. 24, 2002.

(30) Foreign Application Priority Data
Jan. 29, 2001 (DE) 101 03 788.0

(51) Int. Cl. H01H 71/16; H01H 71/22

(52) U.S. Cl. 337/101; 337/99

(57) ABSTRACT

A thermally tripped circuit breaker contains a functional bimetallic strip and a bimetallic support that fixes the functional bimetallic strip, in particular to an enclosure. The bimetallic support is a compensating bimetallic strip that is bent out in the opposite direction (i.e. a pivot direction) to the functional bimetallic strip. Current flows through the two bimetallic strips, and the strips are connected in series.

### CROSS-REFERENCE TO RELATED APPLICATION

This application is a continuation of copending International Application No. PCT/EP02/00701, filed Jan. 24, 2002, which designated the United States and was not published in English.

### BACKGROUND OF THE INVENTION

Field of the Invention

The invention relates to a thermally tripped circuit breaker having a functional bimetallic strip supported by a bimetallic, support. Such a circuit breaker, for example as disclosed in European Patent EP 0 450 366 B1, corresponding to U.S. Pat. No. 5,153,552, is preferably used in motor vehicles.

Motor vehicles are subject to considerable temperature fluctuations depending on the environment and the time of year. This presents problems in ensuring a constant tripping characteristic over considerable temperature fluctuations. The tripping time for the circuit breaker is dependent not only on the current flowing through the breaker and its functional bimetallic strip, but also on the ambient temperature.

### SUMMARY OF THE INVENTION

It is accordingly an object of the invention to provide a thermally tripped circuit breaker that overcomes the above-mentioned disadvantages of the prior art devices of this general type, which has a constant tripping characteristic substantially independently of fluctuations in its ambient temperature.

With the foregoing and other objects in view there is provided, in accordance with the invention, a thermally tripped circuit breaker. The circuit breaker contains a functional bimetallic strip, and a bimetallic support supporting the functional bimetallic strip. The bimetallic support is a compensating bimetallic strip bent out in an opposite direction to the functional bimetallic strip. The functional bimetallic strip and the bimetallic support are electrically connected in series.

Accordingly, both the functional bimetallic strip and the bimetallic support are bimetallic. In this case, current flows through the bimetallic support, which is in the form of a compensating bimetallic strip, as well as through the functional bimetallic strip. The solution is further distinguished by a simple, cost-effective construction.

The bimetallic support and the connecting contact that is electrically connected to the bimetallic support are thus integral, despite the bimetallic support being in the form of a compensating bimetallic strip. This can be produced in a particularly simple manner by the connecting contact being bent away from the functional plane, which is identical to the plane of an enclosure, of the bimetallic support that acts as a compensating bimetallic strip. The functional bimetallic strip and the bimetallic support configured as a compensating bimetallic strip thus in each case form one component having a preferably rectangular outer contour, the ends of one limb of each component being connected to one another, with the outer sides of each component resting against one another, in a way which is simple to produce in terms of manufacturing technology. A fixing hook that is provided can also be part of the bimetallic support configured as a compensating bimetallic strip. This simplifies manufacture.

If the connecting contact is also expediently provided in the form of a bimetallic strip, no problems arise as regards attachment. Temperature stresses are absorbed in the immediate vicinity by the expansion of the active side of the bimetallic connecting contact directly adjacent to the wall of an insulating enclosure for the circuit breaker.

In one advantageous development, in each case one stop is provided, which is fixed to the enclosure and limits the bending-out movements of the functional limb of the functional bimetallic strip and of the bimetallic support acting as the compensating bimetallic strip. In this case, the stop limiting the functional limb of the bimetallic support acts first, in each case, by being appropriately positioned in the enclosure, when the bimetallic strip is heated. This ensures that the tripping function of the breaker has precedence over the compensating function of the bimetallic support. This is important for reliable operation of the circuit breaker.

In accordance with an additional feature of the invention, the functional bimetallic strip is an angled bimetallic strip, preferably having a right angle bend.

In accordance with another feature of the invention, a contact link and a compression spring are provided. The functional bimetallic strip has a first angle limb with a first free end and a second angle limb with a second free end. The first angle limb is a fixing limb and the first free end is fixed to a free end of the bimetallic support and projects in a same direction. The second angle limb is a functional limb and, fixes, in a region of the second free end, the contact link, against an opening pressure of the compression spring, in a switched-on position. Heating of the functional limb results in deflection, allowing an opening movement of the contact link to start, in a bending direction being opposite to the fixing limb.

In accordance with an added feature of the invention, a connecting contact is connected to the bimetallic support. Preferably, the bimetallic support and the connecting contact are integral components.

In accordance with a further feature of the invention, the bimetallic support flanks the fixing limb of the functional bimetallic strip such that they are disposed substantially plane-parallel.

In accordance with another further feature of the invention, the bimetallic support is a compensating bimetallic strip. The free end of the bimetallic support, bends out, when heated, in a given direction opposite to the bending direction of the functional limb which opens a contact. The bimetallic support is a sheet-like layered structure having a layer plane disposed approximately parallel to a plane of the fixing limb of the functional bimetallic strip.

In accordance with another additional feature of the invention, the bimetallic support has a functional limb. The connecting contact contains a layer plane of the functional limb of the bimetallic support, and is bent in a direction opposite to the functional limb of the functional bimetallic strip.

In accordance with another added feature of the invention, the functional bimetallic strip is bent forming a first angled form having an outside and an inside and the bimetallic structure is bent forming a second angled form having an outside and an inside. The first free end of the fixing limb and the free end of the bimetallic support are connected to one another such that they protrude from the outside of the bends of the first and second angled forms of the functional bimetallic strip and the bimetallic support in a same direction, and the first free end and the free end have outer sides resting flat against one another.

In accordance with a further added feature of the invention, the bimetallic support has a functional limb with an active layer, the fixing limb has a passive layer forming outer flanks of the first angled form of the functional bimetallic strip. The passive layer rests against the active layer of the functional limb of the bimetallic support. The bimetallic support has a bending coefficient less than, or at most equal to, that of the functional bimetallic strip.

In accordance with a further additional feature of the invention, an insulating material enclosure contains the functional bimetallic strip. A fixing hook is provided for fixing the circuit breaker in a plug base. The fixing hook is integral with the bimetallic support and flanks the connecting contact in approximately a same plane, and protrudes from the insulating material enclosure.

In accordance with another feature of the invention, the connecting contact is fixed such that the active side of the bimetallic support rests against one wall of the insulating material enclosure.

In accordance with the invention, a first stop and a second stop are fixed to the insulating material enclosure and limit bending-out movements of the second angle limb of the functional bimetallic strip and the functional limb of the bimetallic support acting as the compensating bimetallic strip. The first stop limiting the functional limb of the bimetallic support acting first, in each case, by being appropriately positioned in the insulating material enclosure, when the functional bimetallic strip is heated.

In accordance with a further feature of the invention, the connecting contact has a fixing hole formed therein for receiving a fixing means that passes through the connecting contact, for fixing the connecting contact to the insulating material enclosure.

In accordance with a concomitant feature of the invention, two projections are fixed to the insulating material enclosure. The first angled limb of the functional bimetallic strip is held, as a system pivot, close to an outside of the bend of the first angled form of the functional bimetallic strip, between the two projections. Preferably, the two projections are blade bearings acting on both sides of the first angled limb.

Other features which are considered as characteristic for the invention are set forth in the appended claims.

Although the invention is illustrated and described herein as embodied in a thermally tripped circuit breaker, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective, exploded view of essential parts of a circuit breaker having a configuration according to the invention;

FIG. 2 is a perspective view of a functional bimetallic strip and a bimetallic support, in the form of a compensating bimetallic strip, which are connected to one another to form an integral component;

FIG. 3 is a front-elevational view, looking in the direction III shown in FIG. 2, of the integral bimetallic component;

FIG. 4 is a side-elevational view, in the direction of the arrow IV shown in FIG. 3; and

FIG. 5 is a rear view, in the direction of the arrow V shown in FIG. 4, of the combined bimetallic component.

### DESCRIPTION OF THE PREFERRED EMBODIMENTS

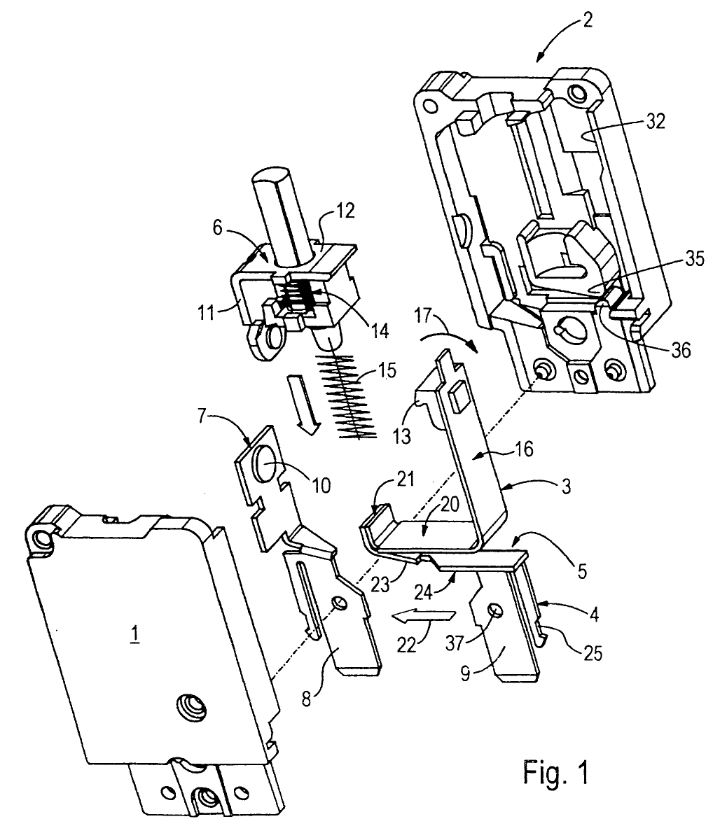

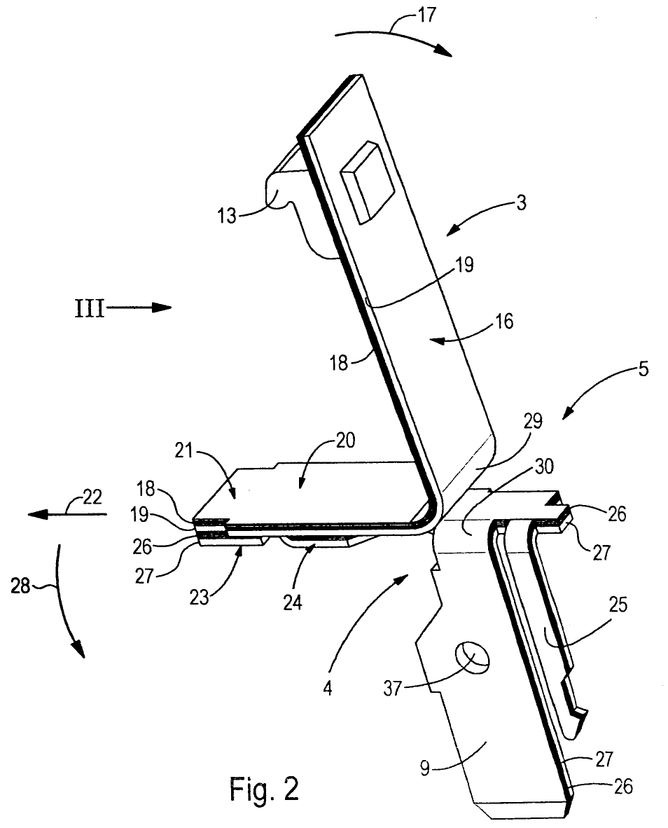

In all the figures of the drawing, sub-features and integral parts that correspond to one another bear the same reference symbol in each case. Referring now to the figures of the drawing in detail and first, particularly, to FIG. 1 thereof, there is shown a circuit breaker which contains an enclosure having two enclosure halves 1, 2, made of an insulating material and with their open sides facing one another, which enclose the functional parts of the circuit breaker such that they are shielded from the outside. When assembled, the circuit breaker thus has a flat cuboid shape, having a separating plane running approximately parallel to the outer surfaces of the enclosure halves 1, 2. The movement plane of the functional parts encapsulated by the two enclosure halves 1, 2 also lies essentially in the separating plane.

The thermally tripped circuit breaker contains a functional bimetallic strip 3 and a bimetallic support 4 that fixes the functional bimetallic strip 3, in particular to the enclosure 1, 2. The bimetallic support 4 is a compensating bimetallic strip 4 that is bent out in the opposite sense to the functional bimetallic strip 3. Current flows through the two bimetallic strips 3, 4, connected in series. In this case, the structural configuration of the circuit breaker substantially corresponds to the subject matter of European Patent EP 0 450 366 B1, but with the substantial difference that both the functional bimetallic strip 3 and the bimetallic support 4 are bimetallic strips. The functional bimetallic strip 3 and the bimetallic support 4 are thus connected to one another to form a bimetallic unit 5.

For reasons of simplicity, to explain the principle of operation of the circuit breaker, reference is made in full to the disclosure content of European Patent EP 0 450 366 B1 which is incorporated by reference herein. The description which follows here is therefore limited substantially to the essential features of the subject of the invention that differ from those of European Patent EP 0 450 366 B1, which is otherwise the subject of the present disclosure of the invention too.

The functional components that are essential for the operation of the circuit breaker according to the invention, apart from the bimetallic unit 5, are a contact link 6 and a fixed contact piece 7 and its plug connection 8. These functional parts are enclosed between the enclosure halves 1, 2.

The current through the connected circuit breaker between the plug connection 8 of the fixed contact piece 7 and a connecting or plug contact 9, which is integral with the bimetallic support 4, of the bimetallic unit 5 flows from the fixed contact 10, which is fixed to the enclosure and is integral with the plug connection 8, via the angled contact link 6 to the functional bimetallic strip 3, and from there via the bimetallic support 4 to the plug contact 9, and vice versa. The fixed contact 10 in this case comes into contact with a vertical limb 11 of the angled contact link 6, the free end of whose horizontal limb 12 engages under a retaining tab 13 on the functional bimetallic strip 3 and, in the process, the horizontal limb 12 is pressed permanently against the underside of the retaining tab 13 by a pivoting compression spring 14 and a tripping spring 15. As long as the functional limb 16 of the functional bimetallic strip 3 assumes its essentially right-angled rest position with respect to the fixed limb 20 of the functional bimetallic strip 3, the retaining tab 13 presses against the free end of the horizontal limb 12 of the contact link 6 and holds the latter connected to the fixed contact 10 and compresses the two springs 14, 15 acting on the contact link 6 in its opening direction.

In the case of an overcurrent, the functional bimetallic strip 3 is heated. Its functional limb 16 bends in the clockwise direction 17 with respect to the bimetallic support 4 that is fixed to the enclosure. The retaining tab 13, which is fixed to the free end of the functional limb 16 of the functional bimetallic strip 3, is, due to the current, drawn back from the position in which it presses against the contact link 6. In consequence, the contact link 6 is pivoted into its open position with the load on the compression springs being reduced. The contact between the bimetallic unit 5 and the fixed contact piece 7 is broken.

The pivoting-out, caused by the functional bimetallic strip 3 being heated, of its functional limb 16 in the clockwise direction 17 is a result of the situation in which an active layer 18 forms an inner side and a passive layer 19 forms the outer side of the essentially right-angled functional bimetallic strip 3. In the case of the figures, the functional limb 16 has a vertical alignment. The other, horizontal limb of the integral functional bimetallic strip 3, having a right-angled bend, is the fixing limb 20. A free end 21 of the fixing limb 20 is fixed to a free end 23 of a horizontal connecting arm or functional limb 24 of the bimetallic support 4, the free end 23 projecting in the same direction (direction 22) and having a horizontal alignment.

The bimetallic support 4 is likewise a bimetallic strip 4. It is integral with the plug contact 9 and with a fixing hook 25 for fixing the circuit breaker in a non-illustrated plug base. The fixing hook 25 protrudes outward, when the circuit breaker is assembled—as do the two plug contacts 8 and 9—from the insulating material enclosure 1, 2. The bimetallic support 4 is fixed or clamped in between the two enclosure halves 1, 2, such that it is fixed to the enclosure 1, 2, when the circuit breaker is assembled.

An active layer 26 of the bimetallic functional limb 24 of the bimetallic support 4 faces the fixing limb 20 of the functional bimetallic strip 3. There is a passive layer 27 of the bimetallic support 4 in the region of the functional limb 24 on the side facing away from the fixing limb 20 of the functional bimetallic strip 3. When the surrounding atmosphere is heated, the functional limb 24 of the bimetallic support 4 is thus bent in the counterclockwise direction, in a direction 28.

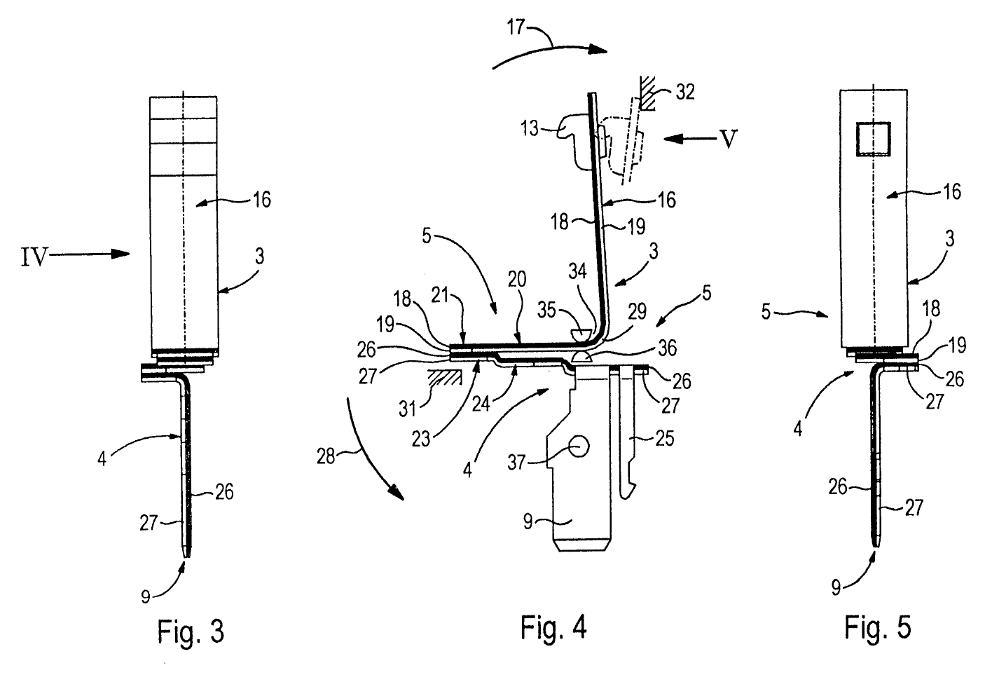

The functional bimetallic support 4, which acts as a compensating bimetallic strip and is itself bimetallic, is a sheet-like layered structure having a layer plane that is approximately parallel to the plane of the fixing limb 20 of the functional bimetallic strip 3. The connecting contact 9 and the fixing hook 25 of the bimetallic support 4 are bent away from the horizontally aligned functional limb 24 of the bimetallic support 4 in the opposite direction to the functional limb 16 of the functional bimetallic strip 3. The connecting arm of the bimetallic support 4 is the functional limb 24 of the compensating bimetallic strip. The pivoting-out movements of the functional limb 16 of the functional bimetallic strip 3 in the clockwise direction 17 and of the functional limb or connecting arm 24 of the bimetallic support 4 in the counterclockwise direction 28 take place with the plane of the drawing in FIG. 4 acting as the pivoting plane. The free ends 21, 23 of the fixing limb 20 of the functional bimetallic strip 3, on the one hand, and of the connecting arm or the functional limb 24 of the bimetallic support 4 protrude from the bends 29 or 30, respectively, of the angled form of the functional bimetallic strip 3 and of the bimetallic support 4 in the same direction (to the left in the drawings). They are connected to one another, with their mutually facing outer sides resting flat against one another, by welding, riveting, screwing or brazing. In the process, the outer passive layer 19 of the fixing limb 20 of the functional bimetallic strip 3 rests against the outer layer of the connecting arm 24 that forms the active layer 26 of the compensating bimetallic strip of the bimetallic support 4.

The bending coefficient of the bimetallic support 4 configured as a compensating bimetallic strip is preferably less than, but at most the equal to, that of the functional bimetallic strip 3. This ensures that the compensation effect exerted on the functional bimetallic strip 3 by the connecting arm 24 of the bimetallic support is limited to a certain extent. This limitation is assisted further by the stop 31 that limits the extent to which the connecting arm 24 of the bimetallic support 4 is bent out in the counterclockwise direction 28 (FIG. 4).

The bending-out movement, in the clockwise direction 17, of the functional limb 16 of the functional bimetallic strip 3 is also limited by the opposing stop 32 that is fixed to the enclosure 1, 2. The stop 31 limiting the functional limb 24 of the compensating bimetallic strip acts, in each case, by being positioned appropriately in the enclosure 1, 2, before the opposing stop 32 limits the pivoting-out of the functional limb 16 of the functional bimetallic strip 3 when the bimetallic strip trips.

The plug contact 9 is bent away from the plane of the connecting arm 24 such that the plug contact 9 is fixed with the active side 26 of its layer structure resting against the wall of the enclosure half 1. On heating, the plug contact 9 therefore presses against the enclosure wall of the enclosure half 1 and is supported by it and not pulled away from it.

A low-resistance bimetallic strip is expediently used as the material for the bimetallic support 4. The plug contact 9, having a plug tongue which projects from the enclosure when the enclosure (enclosure halves 1, 2) is assembled, has a fixing hole 37 through it for the purpose of fixing it to the enclosure 1, 2. An enclosure projection on the enclosure half 1 projects into the fixing hole 37 in an interlocking manner. The fixing limb 20 of the functional bimetallic strip 3 is positioned, close to the outside of the bend 29 and the inside of the bend 34, respectively, of its two limbs 16, 20, between the two enclosure projections 35, 36 of the enclosure half 2. The enclosure projections 35, 36 form the system pivot for the bimetallic unit 5, containing the functional bimetallic strip 3 and the bimetallic support 4.

The bimetallic support 4 is coated with Sn or Ag. This increases its conductivity. This also protects the plug contact 9, in particular in its region outside the enclosure, against corrosion.

The functional bimetallic strip 3 is tripped by overcurrent heating. In this case, the functional bimetallic strip 3 bends out in the clockwise direction 17. At the same time, the free end 23 of the connecting arm 24 acting as the compensating bimetallic strip bends out in the counterclockwise direction 28 to a lesser extent and thus compensates for part of the movement of the functional bimetallic strip 3.

I claim:

1. A thermally tripped circuit breaker, comprising:
a functional bimetallic strip; and
a bimetallic support supporting said functional bimetallic strip, said bimetallic support being a compensating bimetallic strip bent out in an opposite direction to said functional bimetallic strip, said functional bimetallic strip and said bimetallic support being electrically connected in series.

2. The breaker according to claim 1, wherein said functional bimetallic strip is an angled bimetallic strip.

3. The breaker according to claim 2,
further comprising a contact link;
further comprising a compression spring;
wherein said bimetallic support has a free end;
wherein said functional bimetallic strip has a first angle limb with a first free end and a second angle limb with a second free end, said first angle limb being a fixing limb and said first free end is fixed to said free end of said bimetallic support and projects in a same direction; and
wherein said second angle limb being a functional limb and, fixes, in a region of said second free end, said contact link, against an opening pressure of said compression spring, in a switched-on position, and heating of said functional limb results in deflection, allowing an opening movement of said contact link to start, in a bending direction being opposite to said fixing limb.

4. The breaker according to claim 3, further comprising a connecting contact connected to said bimetallic support.

5. The breaker according to claim 4, wherein said bimetallic support flanks said fixing limb of said functional bimetallic strip such that they are disposed substantially plane-parallel.

6. The breaker according to claim 4, wherein said bimetallic support is a compensating bimetallic strip, said free end of said bimetallic support, bends out, when heated, in a given direction opposite to the bending direction of said functional limb which opens a contact.

7. The breaker according to claim 3, wherein said bimetallic support is a sheet-like layered structure having a layer plane disposed approximately parallel to a plane of said fixing limb of said functional bimetallic strip.

8. The breaker according to claim 4, wherein said bimetallic support and said connecting contact are integral components.

9. The breaker according to claim 4, wherein said bimetallic support has a functional limb, said connecting contact contains a layer plane of said functional limb of said bimetallic support, and is bent in a direction opposite to said functional limb of said functional bimetallic strip.

10. The breaker according to claim 6, wherein:
said functional bimetallic strip is bent forming a first angled form having an outside and an inside;
said bimetallic structure is bent forming a second angled form having an outside and an inside; and
said first free end of said fixing limb and said free end of said bimetallic support are connected to one another such that they protrude from said outside of said bends of said first and second angled forms of said functional bimetallic strip and said bimetallic support in a same direction, and said first free end and said free end have outer sides resting flat against one another.

11. The breaker according to claim 10, wherein:
said bimetallic support has a functional limb with an active layer; and
said fixing limb has a passive layer forming outer flanks of said first angled form of said functional bimetallic strip, said passive layer resting against said active layer of said functional limb of said bimetallic support.

12. The breaker according to claim 1, wherein said bimetallic support has a bending coefficient less than, or at most equal to, that of said functional bimetallic strip.

13. The breaker according to claim 10, further comprising an insulating material enclosure containing said functional bimetallic strip.

14. The breaker according to claim 13, further comprising a fixing hook for fixing the circuit breaker in a plug base, said fixing hook being integral with said bimetallic support and flanks said connecting contact in approximately a same plane, and protrudes from said insulating material enclosure.

15. The breaker according to claim 13, wherein:
said bimetallic support has a functional limb with an active side; and
said connecting contact is fixed such that said active side of said bimetallic support rests against one wall of said insulating material enclosure.

16. The breaker according to claim 15, further comprising a first stop and a second stop fixed to said insulating material enclosure and limit bending-out movements of said second angle limb of said functional bimetallic strip and said functional limb of said bimetallic support acting as said compensating bimetallic strip, said first stop limiting said functional limb of said bimetallic support acting first, in each case, by being appropriately positioned in said insulating material enclosure, when said functional bimetallic strip is heated.

17. The breaker according to claim 13, wherein said connecting contact has a fixing hole formed therein for receiving a fixing means that passes through said connecting contact, for fixing said connecting contact to said insulating material enclosure.

18. The breaker according to claim 13, further comprising two projections fixed to said insulating material enclosure, said first angled limb of said functional bimetallic strip is held, as a system pivot, close to said outside of said bend of said first angled form of said functional bimetallic strip, between said two projections.

19. The breaker according to claim 18, wherein said two projections are blade bearings acting on both sides of said first angled limb.

20. The breaker according to claim 2, wherein said angled bimetallic strip has a right-angled bend.
